(19) United States
(12) Patent Application Publication
(10) Pub. No.: US 2016/0321454 A1
(43) Pub. Date: Nov. 3, 2016

(54) BINARY COMPONENT EXTRACTION AND EMBEDDING

(71) Applicant: Purdue Research Foundation, West Lafayette, IN (US)

(72) Inventors: Xiangyu Zhang, West Lafayette, IN (US); Zhui Deng, West Lafayette, IN (US); Dongyan Xu, West Lafayette, IN (US)

(73) Assignee: PURDUE RESEARCH FOUNDATION, West Lafayette, IN (US)

(21) Appl. No.: 14/595,922

(22) Filed: Jan. 13, 2015

Related U.S. Application Data
(60) Provisional application No. 61/926,496, filed on Jan. 13, 2014.

(51) Int. Cl. G06F 21/56; G06F 21/54; G06F 17/30; G06F 9/445; G06F 11/36; G06F 9/44

(52) U.S. Cl. CPC G06F 21/566; G06F 11/3668; G06F 8/36; G06F 17/30952; G06F 8/65; G06F 21/54; G06F 2221/033

(57) ABSTRACT

Disclosed is a system and method for removing binary components from machine-language programs or inserting binary components into such programs. The method may include modifying a code sequence of the program (inserting or removing instructions), analyzing the program to determine one or more adjustment(s) to address(es) (of code or data references, direct or indirect) in the program, and modifying operand(s) of one or more instruction(s) in the program to reflect corresponding one(s) of the adjustment(s) (e.g., change offsets or add displacements to register-indirect accesses).

### RELATED APPLICATIONS

The present application claims the benefit of U.S. provisional application Ser. No. 61/926,496, filed Jan. 13, 2014, the contents of which are hereby incorporated by reference in its entirety.

### STATEMENT OF FEDERALLY SPONSORED RESEARCH OR DEVELOPMENT

This invention was made with Government support under Contract No. HR0011-12-2-0006 awarded by the Defense Advanced Research Projects Agency (DARPA). The government has certain rights in the invention.

### TECHNICAL FIELD

The present application relates to analysis and repair of software, and particularly to modification of machine code.

### BACKGROUND

It is desirable to analyze malware, viruses, and other undesired or ill-behaved software programs to determine how to counteract their effects, and then to change those programs to remove undesirable behavior. Source code for these is generally not available, so analysis and manipulation take place at the machine code level (equivalently, at the assembly-language level; this is referred to herein as the “binary” level as opposed to the “source” level). It is also desirable to manipulate benign programs at a binary level, e.g., to apply patches to software components in the field. However, machine code is compiled or assembled with a specific layout of memory. There is, therefore, a need for a way of manipulating binary programs while retaining desirable functionality of those programs.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a diagram showing an exemplary dataflow according to various aspects; and

FIG. 2 is a high-level diagram showing the components of a data-processing system.

The attached drawings are for purposes of illustration and are not necessarily to scale.

### DETAILED DESCRIPTION

In the following description, some aspects will be described in terms that would ordinarily be implemented as software programs. Those skilled in the art will readily recognize that the equivalent of such software can also be constructed in hardware, firmware, or micro-code. Because data-manipulation algorithms and systems are well known, the present description will be directed in particular to algorithms and systems forming part of, or cooperating more directly with, systems and methods described herein. Other aspects of such algorithms and systems, and hardware or software for producing and otherwise processing the signals involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

The disclosed system and method is a technique for removing binary components from machine-language programs or inserting binary components into such programs. Exemplary users include malware-defense investigators; antivirus software companies; anyone analyzing malware, spyware, adware, viruses, or other potentially-disruptive code or code of unknown provenance; software vendors that distribute patches; and developers desiring to migrate patches to common components across projects.

Throughout this disclosure, examples are given of INTEL x86 assembly and processor architecture. The techniques described herein can be used on any processor, and can be used with any object-file format (e.g., executables, objects, static libraries, or dynamically-linked libraries in the DOS MZ, WINDOWS NE or PE, LINUX a.out or ELF, MACINTOSH Mach-O, or other formats).

In flowcharts herein, the steps can be performed in any order except when otherwise specified, or when data from an earlier step is used in a later step. References to specific components in explanations of flowcharts are exemplary and not limiting.

It is desirable to add or extract material to or from a binary, even when source is not available, e.g., to extract or insert binary components. E.g., to retrofit value-added security functions into target. If the function is already compiled, such insertion permits reusing the function without re-implementing it. Or, e.g., to pull malicious functions out of malware, e.g., to look at other (e.g., non-malicious, or at least non-damaging) aspects. This permits investigating command-and-control of malware without having it damage the computer or host on which the investigation is performed. It is further desirable to improve security, accountability, and reliability of software. The disclosed system and method can operate as a static tool on standalone binaries (executable or library) when not running. The disclosed system and method can also operate on an in-RAM image. This permits enhancing the security of commercial software. The disclosed system and method is a generic binary rewriter that can add individual instructions or whole functions. It can move code cross-binary: out of one program, into another.

In view of the foregoing, various aspects provide ways of modifying binary programs without destroying the functionality thereof. A technical effect is to provide a modified binary on a tangible non-transitory computer-readable storage medium and to improve the reliability and functionality of the computer system being operated.

Various aspects permit removing binary components from machine-language programs or inserting binary components into such programs. An important and unique property of these aspects is the ability to permit a user to insert code into programs to detect the presence of a third party, including a malware program, spyware program, computer virus, or other potentially-disruptive code, trying to gain knowledge of a cryptographic key or other secret information. A third party trying to eavesdrop on a key must in some way measure it, thus introducing detectable anomalies. By using the disclosed system and method, a communication system can be implemented which detects eavesdropping, and this communication system can use or include programs that did not originally include eavesdropping-detection code. In case of eavesdropping, the code inserted in the communication system by the disclosed system and method can abort communications or take other cyber-security actions. The disclosed system and method can also be used to introduce other cybersecurity code into existing programs. Examples include data encryption or decryption code; code to verify signatures of the modified program itself, of other programs, or of digital certificates; and code to communicate securely with a user (e.g., code to request the kernel recognize a secure attention sequence such as Ctrl-Alt-Del before proceeding).

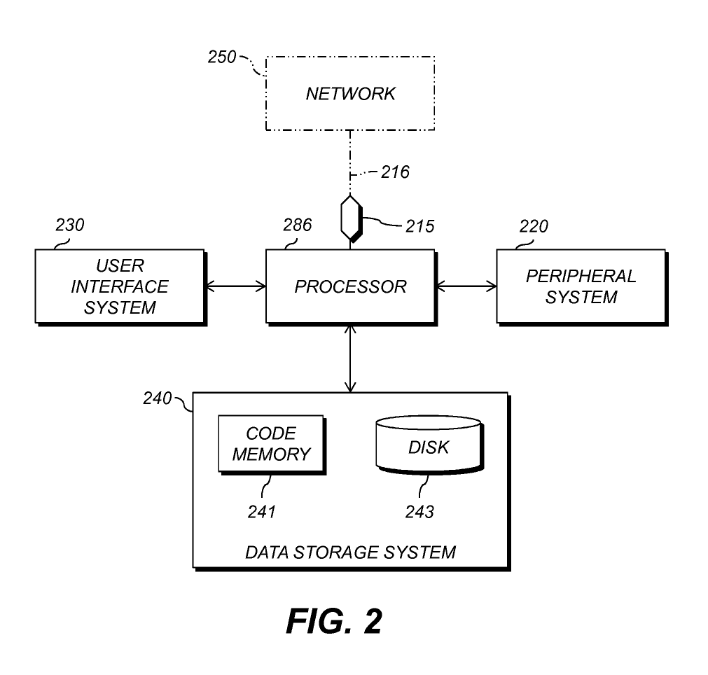

In various aspects, a method of modifying a software program in a memory (RAM, ROM, hard drive, or other; see FIG. 2) of a data-processing system, the method comprising automatically performing the following steps using a processor 286 (FIG. 2):

modifying a code sequence of the program (inserting or removing instructions);

analyzing the program to determine one or more adjustment(s) to address(es) (of code or data references, direct or indirect) in the program; and

modifying operand(s) of one or more instruction(s) in the program to reflect corresponding one(s) of the adjustment(s) (e.g., change offsets or add displacements to register-indirect accesses).

The method can further include inserting one or more redirection instruction(s), the redirection instruction(s) including table lookups (e.g., mov eax, Map(eax) or its expansion) and jumps (e.g., jmp short from or around anchors). The modifying step can include determining the operand(s) to be modified so that the software program has the same behavior before and after modification. This correspondence of behavior can be determined, e.g., by inspection of the machine code or corresponding assembly code, by execution tracing, or by static analysis. The phrase “same behavior” does not require that the execution time of the program be unchanged. Execution time can change, e.g., due to the insertion of redirection instructions. However, in various aspects, the modified program produces the same output as the unmodified program for a given input.

A method of modifying a deployed software program in a memory of a data-processing system without source code for the deployed software program is also provided, the method comprising automatically performing the following steps using a processor: modifying the code sequence of the program; analyzing the program to determine one or more adjustment(s) to address(es) in the program; and modifying operand(s) of one or more instruction(s) in the program to reflect corresponding one(s) of the adjustment(s) to retain the original functionality of the software under the modifications.

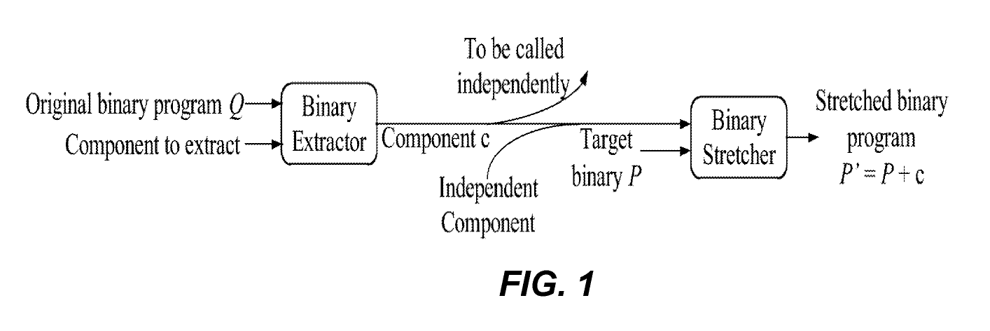

FIG. 1 is a diagram showing an exemplary dataflow according to various aspects. As shown, the process includes two main functional blocks: a binary extractor and a binary stretcher. The binary extractor is responsible for extracting a designated functional component c from an original binary program Q. The component c includes both the code and data of the functional component. The extractor removes the unwanted code and data from Q and then collapses the remaining data and code into a re-usable component c that occupies a contiguous virtual address region. More importantly, the instructions in c are properly patched for repositioning. It shall be understood that c can either be called as a library function or be embedded directly in another binary program. The binary stretcher is responsible for stretching the target binary program P to make “room” (holes in its address space) to embed a function component. As shown in FIG. 1, the stretcher takes the target binary P and the to-be-embedded component c as input, stretches P, and patches the code in P to allow the embedding of c. The output of the stretcher is a “stretched” binary program P=P+c that is ready for execution.

Both the binary extractor and stretcher may be based on the same binary stretching algorithm. The overarching idea is to shift instructions for creating space (by stretcher) or squeezing out unwanted space (by extractor). The algorithm focuses on patching the control transfer and global data reference instructions by precisely computing the offsets they need to be adjusted. For instance, if a component with size |c|=n is inserted, all the original instructions following the insertion point will be shifted by n bytes, and control transfers to any of the shifted instructions need to be incremented by n. The algorithm takes the subject binary and a list of virtual address intervals called “snippets” representing (1) the holes to be created in the binary in the case of stretching or (2) the unwanted instruction/data blocks in the case of shrinking (extraction). First, for each byte in the binary, the algorithm computes a mapping between its original index in the binary and its corresponding index after the snippets are inserted/removed. After that, the algorithm patches address operands in control transfer and global data reference instructions, and copies each byte to its mapped location according to the mapping.

To address the challenge of handling indirect calls and call back functions invoked by external libraries, a further process is provided which stretches a subject binary at the original entries of functions that are potential targets of indirect calls, creating small holes (usually a few bytes) to hold a long jump instruction to forward any calls to those functions to their shifted locations. These holes should not be shifted by any stretching/shrinking operations. They stay in their original positions and thus are referred to herein as anchors. The process precisely takes into account these anchors when performing stretching/shrinking. To handle indirect jumps, an efficient perfect hashing scheme is utilized to translate jump targets dynamically. This approach patches indirect jumps/calls in both the component and the target binary. With the presence of anchors, fixing control flow transfer instructions becomes more challenging. A further process is therefore applied which divides the stretching/shrinking operation into two phases. In phase one, the subject binary program is stretched/shrunk using the prior process to create space for the inserted snippets or removed blocks. Then the stretched/shrunk binary is further stretched to insert anchors using a similar procedure. Separating the two phases substantially simplifies the interference from anchors.

FIG. 2 is a high-level diagram showing the components of an exemplary data-processing system for analyzing data and performing other analyses described herein, and related components. The system includes a processor 286, a peripheral system 220, a user interface system 230, and a data storage system 240. The peripheral system 220, the user interface system 230 and the data storage system 240 are communicatively connected to the processor 286. Processor 286 can be communicatively connected to network 250 (shown in phantom), e.g., the Internet or an X.25 network, as discussed below. Any data-processing device described herein can include one or more of systems 286, 220, 230, 240, and can each connect to one or more network(s) 250. Processor 286, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 286 can implement processes of various aspects described herein. Processor 286 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 286 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 220, user interface system 230, and data storage system 240 are shown separately from the data processing system 286 but can be stored completely or partially within the data processing system 286.

The peripheral system 220 can include one or more devices configured to provide digital content records to the processor 286. For example, the peripheral system 220 can include digital still cameras, digital video cameras, cellular phones, or other data processors. The processor 286, upon receipt of digital content records from a device in the peripheral system 220, can store such digital content records in the data storage system 240.

The user interface system 230 can include a mouse, a keyboard, another computer (connected, e.g., via a network or a null-modem cable), or any device or combination of devices from which data is input to the processor 286. The user interface system 230 also can include a display device, a processor-accessible memory, or any device or combination of devices to which data is output by the processor 286. The user interface system 230 and the data storage system 240 can share a processor-accessible memory.

In various aspects, processor 286 includes or is connected to communication interface 215 that is coupled via network link 216 (shown in phantom) to network 250. For example, communication interface 215 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 215 sends and receives electrical, electromagnetic or optical signals that carry digital or analog data streams representing various types of information across network link 216 to network 250. Network link 216 can be connected to network 250 via a switch, gateway, hub, router, or other networking device.

Processor 286 can send messages and receive data, including program code, through network 250, network link 216 and communication interface 215. For example, a server can store requested code for an application program (e.g., a JAVA applet) on a tangible non-volatile computer-readable storage medium to which it is connected. The server can retrieve the code from the medium and transmit it through network 250 to communication interface 215. The received code can be executed by processor 286 as it is received, or stored in data storage system 240 for later execution.

Data storage system 240 can include or be communicatively connected with one or more processor-accessible memories configured to store information. The memories can be, e.g., within a chassis or as parts of a distributed system. The phrase “processor-accessible memory” is intended to include any data storage device to or from which processor 286 can transfer data (using appropriate components of peripheral system 220), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 240 can be a tangible non-transitory computer-readable storage medium, i.e., a non-transitory device or article of manufacture that participates in storing instructions that can be provided to processor 286 for execution.

In an example, data storage system 240 includes code memory 241, e.g., a RAM, and disk 243, e.g., a tangible computer-readable rotational storage device such as a hard drive. Computer program instructions are read into code memory 241 from disk 243. Processor 286 then executes one or more sequences of the computer program instructions loaded into code memory 241, as a result performing process steps described herein. In this way, processor 286 carries out a computer implemented process. For example, steps of methods described herein, blocks of the flowchart illustrations or block diagrams herein, and combinations of those, can be implemented by computer program instructions. Code memory 241 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 286 (and possibly also other processors), to cause functions, acts, or operational steps of various aspects herein to be performed by the processor 286 (or other processor). Computer program code for carrying out operations for various aspects described herein may be written in any combination of one or more programming language(s), and can be loaded from disk 243 into code memory 241 for execution. The program code may execute, e.g., entirely on processor 286, partly on processor 286 and partly on a remote computer connected to network 250, or entirely on the remote computer. The breakpoint handler can communicate with a remote debugger, e.g., via a serial link or network connection.

The invention is inclusive of combinations of the aspects described herein. References to “a particular aspect” and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. A method of modifying a software program in a memory of a data-processing system, the method comprising automatically performing the following steps using a processor:
a) modifying at least one code sequence of the program;
b) analyzing the program to determine one or more adjustments to instruction and data addresses in the program; and
c) modifying operands of one or more instructions in the program to reflect corresponding at least one of the adjustments.

2. The method according to claim 1, further including inserting one or more redirection instruction(s), the redirection instruction(s) including address mapping table lookups and jumps.

3. The method according to claim 1, wherein the modifying step includes determining the operands to be modified so that the software program has the same behavior before and after modification.

4. The method according to claim 1, further comprising extracting code sequences and data of the program as stand-alone software libraries or reusable components.

5. The method according to claim 4, further including inserting one or more of the extracted components and the code sequences to use the components into a second software program.

6. The method according to claim 1, wherein the software program is malware.

7. A system, comprising:
a) a computer processor;
b) a memory storage device coupled to the processor and comprising computer readable instructions for executing a method modifying a software program in the memory, the method comprising:
i) modifying at least one code sequence of the program;
ii) analyzing the program to determine one or more adjustments to instruction and data addresses in the program; and
iii) modifying operands of one or more instructions in the program to reflect corresponding at least one of the adjustments.

8. The system according to claim 7, the method further including inserting one or more redirection instruction(s), the redirection instruction(s) including address mapping table lookups and jumps.

9. The system according to claim 7, wherein the modifying step includes determining the operands to be modified so that the software program has the same behavior before and after modification.

10. The system according to claim 7, the method further comprising extracting code sequences and data of the program as stand-alone software libraries or reusable components.

11. The system according to claim 10, the method further including inserting one or more of the extracted components and the code sequences to use the components into a second software program.

12. The system according to claim 7, wherein the software program is malware.
